(19) United States
(12) Patent Application Publication
(10) Pub. No.: US 2011/0261381 A1
(43) Pub. Date: Oct. 27, 2011

(54) Image Forming Apparatus

(75) Inventor: Yukiyoshi HANAYAMA, Inazawa-shi (JP)

(73) Assignee: BROTHER KOGYO KABUSHIKI KAISHA, Nagoya-shi (JP)

(21) Appl. No.: 13/070,604

(22) Filed: Mar. 24, 2011

(30) Foreign Application Priority Data
Apr. 21, 2010 (JP) 2010-097487

(51) Int. Cl. G06F 3/12

(52) U.S. Cl. 358/1.13

(57) ABSTRACT

An MFP has: a receiving section receiving a FAX reception request and FAX data; and an image forming section capable of forming a color image. When an execution condition for acquisition processing of acquiring information used for adjusting the image forming section is satisfied, the MFP executes the acquisition processing in response to a trigger defined as start or end of processing of a print job. Further, when receiving a FAX reception request in a state that the execution condition for acquisition processing is satisfied, the MFP notifies function information concerning the function of the image forming section (e.g., information indicating that color image formation is not available), to a FAX device of sender.

### CROSS-REFERENCE TO RELATED APPLICATIONS

This non-provisional application claims priority under 35 U.S.C. §119(a) on Patent Application No. 2010-097487 filed in Japan on Apr. 21.2010, the entire contents of which are hereby incorporated by reference.

### TECHNICAL FIELD

The present invention relates to an image forming apparatus in which a mark used for adjusting an image forming section is formed and then based on a correction value acquired by detecting the mark, the image forming section is adjusted and, in particular, to an image forming apparatus having a receiving section receiving a FAX reception request and FAX data and an image forming section capable of forming a color image.

### BACKGROUND

In the prior art, in an image forming apparatus, the image forming section is adjusted such that deviation should not arise in the position or the density of an image. As a procedure of adjusting the image forming section, for example, first, a registration pattern serving as a mark used for adjusting the image forming section is formed for each color on a belt member for sheet conveyance. Then, the amount of deviation (a correction value) between the registration pattern of basis color and the registration pattern of each to-be-tested color is acquired, and then based on the correction value, the position deviation of the image of each to-be-tested color is corrected.

Further, a technique is known that the acquisition of correction values is linked to image formation. For example, Japanese Patent Application Laid-Open No. 2008-003496 discloses a technique that when vibration is detected in an image forming apparatus in a standby state, a mark used for adjusting the image forming section before image formation is formed.

### SUMMARY

Nevertheless, the conventional image forming apparatus described above has a problem as follows. That is, in a case that a mark used for adjusting the image forming section is formed in linkage with image formation, a possibility arises that such a mark used for adjusting the image forming section is formed at each time of image formation. For example, in the image forming apparatus described in Japanese Patent Application Laid-Open No. 2008-003496, when the image forming apparatus is rocked frequently, the requirement for formation of a mark used for adjusting the image forming section is frequently satisfied at the time of image formation. Thus, a mark is formed frequently. Then, such frequent mark formation causes useless consumption of consumable supplies.

The present invention has been devised for resolving the problem in the conventional image forming apparatus described above. That is, an object of the present invention is to provide an image forming apparatus in which occasions that a mark used for adjusting an image forming section is formed are reduced so that useless consumption of consumable supplies is controlled.

An image forming apparatus having been devised for the purpose of resolving the problem is an image forming apparatus comprising: receiving means receiving a FAX reception request and FAX data; processing means processing the received FAX data so as to generate a print job; image forming means capable of forming a color image based on the print job; execution means, in response to a trigger defined as start or end of processing of a print job containing color image formation, executing acquisition processing for acquiring information used for adjusting the image forming means; judging means judging whether an execution condition for the acquisition processing is satisfied; and notification means, when the receiving means receives a FAX reception request in a state that the judging means has judged that the execution condition for acquisition processing has been satisfied, notifying function information concerning a function of the image forming means, to a sender of the FAX reception request.

In the image forming apparatus according to the present invention, when the execution condition for acquisition processing of acquiring information used for adjusting the image forming means is satisfied, the acquisition processing is executed in response to a trigger defined as the start or end of processing of a print job. This acquisition processing is executed in response to a trigger defined as the start or end of processing of a print job containing color image formation. The timing of execution of the acquisition processing may be “before the printing”, “during the printing”, or “after the printing” of color image formation contained in the print job. Further, the image forming apparatus according to the present invention is capable of notifying function information concerning the function of the image forming means. Then, when receiving a FAX reception request in a state that the execution condition for acquisition processing is satisfied, the image forming apparatus according to the present invention notifies the function information concerning the function of the image forming means, to the sender of the FAX reception request.

That is, in the printing of FAX data, high image quality is seldom required. Thus, the acquisition processing seldom provides an advantage. Accordingly, in the image forming apparatus according to the present invention, when a FAX reception request is received in a state that the execution condition for acquisition processing is satisfied, at the time of negotiation for establishing the communication, function information concerning the function of the image forming means is replied to the sender of the FAX reception request. In accordance with this, the sender does not transmit FAX data serving as a trigger for execution of the acquisition processing. As a result, the acquisition processing is not executed. That is, the number of times of execution of acquisition processing (i.e., the number of times of formation of a mark that causes consumption of colorant) is reduced.

According to the present invention, an image forming apparatus is realized in which occasions that a mark used for adjusting the image forming means is formed are reduced so that useless consumption of consumable supplies is controlled.

The above and further objects and features will more fully be apparent from the following detailed description with accompanying drawings.

### BRIEF DESCRIPTION OF THE SEVERAL VIEWS OF THE DRAWINGS

FIG. 1 is a block diagram illustrating a configuration of an MFP according to an embodiment;

FIG. 2 is a schematic diagram illustrating a configuration of an image forming section of the MFP;

FIG. 3 is a conceptual diagram illustrating a configuration of mark sensors of the MFP illustrated in FIG. 2;

FIG. 4 is a diagram illustrating an example of a database storing user information;

FIG. 5 is a flow chart illustrating a procedure of FAX transmission processing in a FAX device on the transmitting side according to a first embodiment;

FIG. 6 is a flow chart illustrating a procedure of FAX receiving processing in an MFP on the receiving side according to the first embodiment;

FIG. 7 is a flow chart illustrating a procedure of printing processing in the MFP on the receiving side according to the first embodiment;

FIG. 8 is a flow chart illustrating a procedure of FAX receiving processing in the MFP on the receiving side according to a second embodiment; and

FIG. 9 is a flow chart illustrating a procedure of printing processing for data stored in the MFP on the receiving side according to the second embodiment.

### DETAILED DESCRIPTION

Embodiments of implementing the image forming apparatus according to the present invention are described below in detail with reference to the accompanying drawings. In these embodiments, the present invention is applied to a multi function peripheral (MFP) having a color printing function and a FAX transmitting/receiving function.

### [Overall Configuration of MFP]

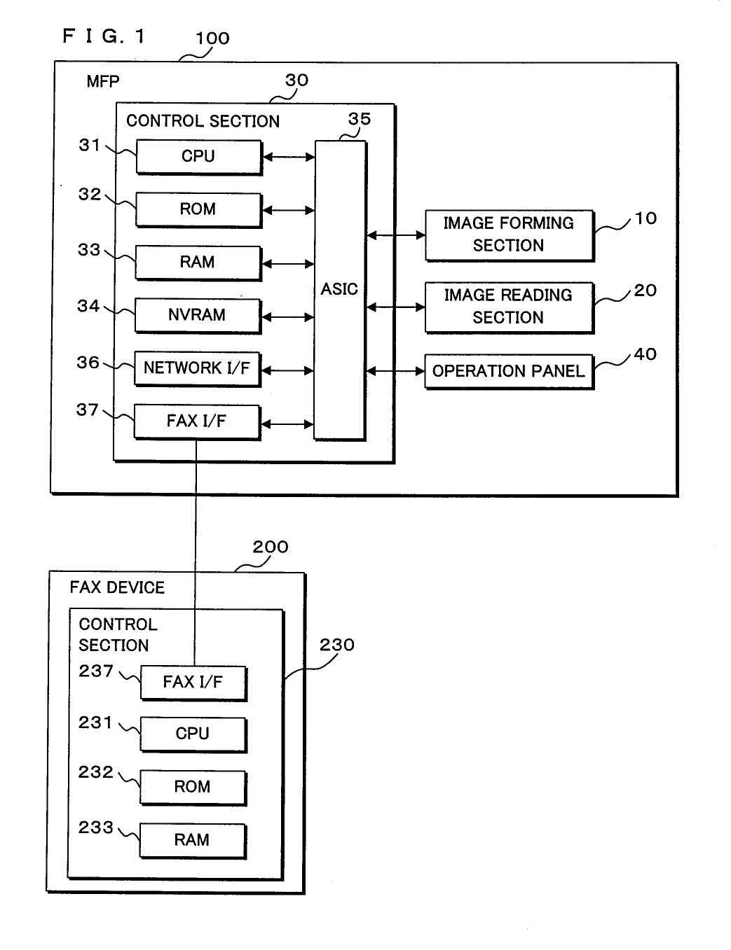

As illustrated in FIG. 1, an MFP 100 according to the present embodiment has a control section 30 (an example of execution means, judging means, selecting means, and processing means) provided with: a CPU 31; a ROM 32; a RAM 33 (an example of second storage means); an NVRAM (nonvolatile RAM) 34 (an example of second storage means); an ASIC 35; a network interface 36 (an example of notifying means and receiving means); and a FAX interface 37 (an example of notifying means and receiving means). Further, the control section 30 is electrically connected to: an image forming section 10 forming an image onto a sheet; an image reading section 20 reading an image on a document; and an operation panel 40 used for displaying the situation of operation and receiving input operation from a user.

The ROM 32 stores: various kinds of control programs controlling the MFP 100; various kinds of setting and initial values; and the like. The RAM 33 is used as a working area into which various kinds of control programs are read or alternatively as a storage area into which image data is stored temporarily.

In accordance with a control program read from the ROM 32 and signals sent from various kinds of sensors, by using the CPU 31, the control section 30 controls the individual components of the MFP 100 via the ASIC 35, with storing the processing result in the RAM 33 or the NVRAM 34.

The network interface 36 is connected to a network so as to realize connection to other information processing apparatuses (e.g., a personal computer (PC)). The FAX interface 37 is connected to a telephone line so as to realize connection to a FAX device 200 of the other party. As such, data communication is achieved with external devices through the network interface 36 or the FAX interface 37.

### [Configuration of FAX Device]

As illustrated in FIG. 1, the FAX device 200 according to the present embodiment has a control section 230 (an example of conversion means) provided with: a CPU 231; a ROM 232; a RAM 233; and a FAX interface 237 (an example of receiving means and transmitting means).

The ROM 232 stores: various kinds of control programs controlling the FAX device 200; various kinds of setting and initial values; and the like. The RAM 233 is used as a working area into which various kinds of control programs are read or alternatively as a storage area into which FAX data containing image data is stored temporarily.

In accordance with a control program read from the ROM 232, by using the CPU 231, the control section 230 controls the individual components of the FAX device 200 with storing the processing result in the RAM 233.

The FAX interface 237 is connected to a telephone line so as to realize connection to an MFP 100 of the other party. Thus, data communication is achieved with external devices through the FAX interface 237.

### [Configuration of Image Forming Section of MFP]

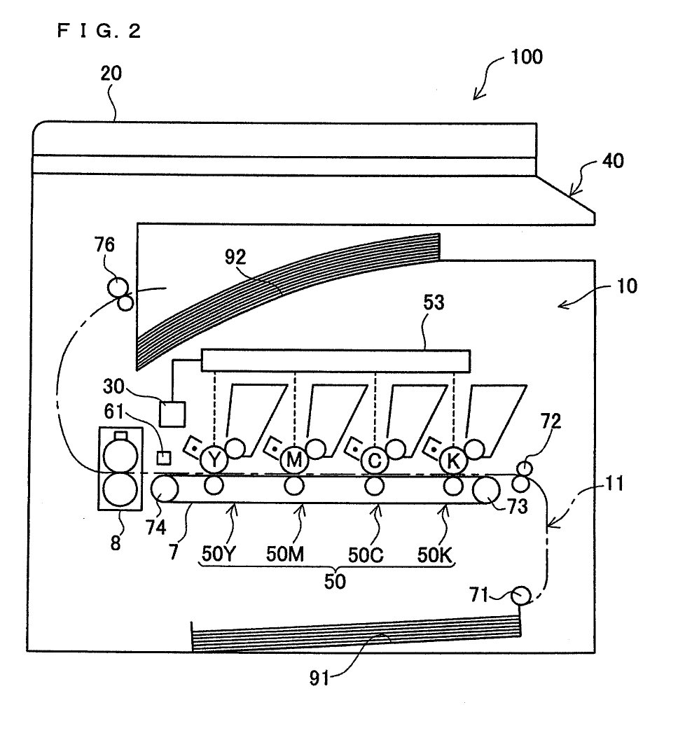

Subsequently, the configuration of the image forming section 10 of the MFP 100 is described below with reference to FIG. 2. The image forming section 10 has: a processing section 50 forming a toner image by electrophotography and then transferring the toner image onto a sheet; a fixing device 8 fixing not-yet-fixed toner on the sheet; a sheet feed tray 91 on which sheets having not yet undergone image transfer are placed; and a sheet discharge tray 92 on which sheets having undergone image transfer are placed. The image reading section 20 is arranged above the image forming section 10.

Further, in the image forming section 10, a conveyance path 11 (illustrated with an alternate long and short dash line in FIG. 2) having an approximate S-shape is provided such that the sheet accommodated in the sheet feed tray 91 located in the bottom part is guided through a feed roller 71, registration rollers 72, the processing section 50, the fixing device 8, and discharge rollers 76 into the sheet discharge tray 92 located in the upper part.

The processing section 50 is capable of forming a color image, in which processing sections respectively corresponding to colors of yellow (Y), magenta (M), cyan (C), and black (K) are arranged in parallel. Specifically, the process section 50 includes a processing section 50Y forming an image in yellow Y, a processing section 50M forming an image in magenta M, a processing section 50C forming an image in cyan C, and a processing section 50K forming an image in black K. These processing sections 50Y, 50M, 50C, and 50K are arranged at equal intervals in a sheet conveying direction.

In the processing section 50, the surface of a photosensitive body is uniformly charged by a charging device. Thereafter, the surface of the photosensitive body undergoes exposure to light from an exposure device 53, so that an electrostatic latent image for an image to be formed in a sheet is formed on the surface of the photosensitive body. Then, toner is supplied to the photosensitive body by a developing device. As a result, the electrostatic latent image on the photosensitive body is visualized as a toner image.

Further, the image forming section 10 has: the exposure device 53 irradiating each of the processing sections 50Y, 50M, 50C, and 50K with light; a conveyance belt 7 conveying a sheet to the transfer position of each of the processing sections 50Y, 50M, 50C, and 50K; and a mark sensor 61 detecting a registration pattern formed on the conveyance belt 7.

The conveyance belt 7 is an endless belt member suspended around conveyance rollers 73 and 74, and is formed from resin material such as polycarbonate. When the conveyance roller 74 is driven and rotated, the conveyance belt 7 circulates counterclockwise when viewed in the paper surface of FIG. 2. As a result, a sheet placed on the upper face of the conveyance belt 7 is conveyed from the registration roller 72 side toward the fixing device 8 side.

In the image forming section 10, a sheet is extracted one by one from those placed on the sheet feed tray 91, then the extracted sheet is conveyed onto the conveyance belt 7, and then the toner image formed by the processing section 50 is transferred onto the conveyed sheet. At that time, in color printing, a toner image is formed by each of the processing sections SOY, 50M, 50C, and 50K, and then these toner images are superimposed and transferred onto the sheet. In contrast, in monochrome printing, a toner image is formed only by the processing section 50K and then transferred onto the sheet. Thereafter, in the image forming section 10, the sheet on which the toner image has been transferred is conveyed to the fixing device 8. Then, the toner image is thermally fixed to the sheet by the fixing device 8, and then the sheet having undergone the fixing is discharged onto the sheet discharge tray 92.

Further, the mark sensor 61 is located in the downstream of the processing sections 50Y, 50M, 50C, and 50K and in the upstream of the fixing device 8 in the sheet conveying direction, and detects the pattern formed on the conveyance belt 7 and used for adjusting the image forming section 10.

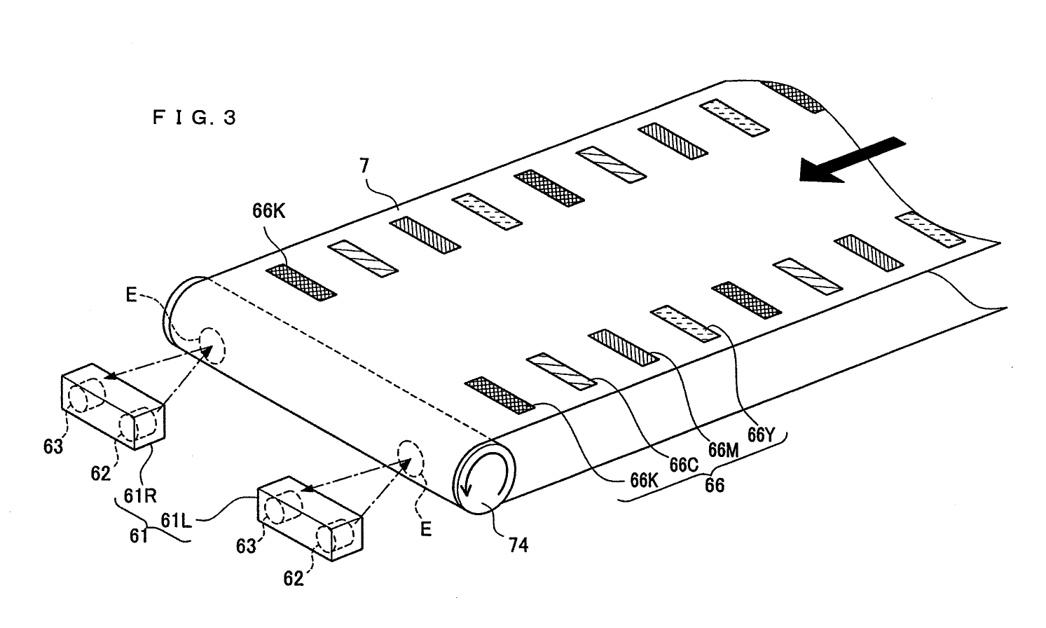

Specifically, as illustrated in FIG. 3, the mark sensor 61 includes two sensors consisting of a sensor 61R arranged on the right-hand side and a sensor 61L arranged on the left-hand side in the width direction of the conveyance belt 7. Each of the sensors 61R and 61L is a reflection-type photo sensor constructed from a pair of a light emitting element 62 (e.g., an LED) and a light receiving element 63 (e.g., a photo transistor). In the mark sensor 61, the light emitting element 62 irradiates the surface (a dotted-line region E in FIG. 3) of the conveyance belt 7 with light in an oblique direction, and then the light receiving element 63 receives the reflected light. Thus, the mark used for adjusting the image forming section 10 is detected based on the difference between the quantity of the light received during the passage of the mark 66 used for adjusting the image forming section 10 (the mark 66 in FIG. 3 is an example of a mark for position deviation correction) and the quantity of the light received directly from the conveyance belt 7.

### [Adjustment of Image Forming Section of MFP]

Subsequently, the adjustment of the image forming section 10 in the MFP 100 is described below. In the MFP 100, the adjustment of the image forming section 10 includes: position deviation correction for adjusting the positions of the images of individual colors; and density deviation correction for adjusting the densities of individual colors.

The adjustment of the image forming section 10 is briefly described below for an example of position deviation correction. The position deviation correction includes: acquisition processing for acquiring the amount of deviation (a correction value) for each color relative to a reference color; and correction processing for correcting the position of the image of each color based on the acquired correction value. The acquisition processing is executed when a predetermined execution condition is satisfied. Employable execution conditions for acquisition processing include the number of printed sheets after the previous obtaining process, the power-ON duration, the temperature condition, the humidity condition, and detection of vibration. Details of the timing of execution of acquisition processing are described later. The correction processing is performed, for example, at each time of execution of printing.

In the acquisition processing, first, the processing sections 50Y, 50M, 50C, and 50K form a registration pattern serving as an image pattern for position deviation correction. Specifically, as illustrated in FIG. 3, the registration pattern is composed of a mark group (referred to as a “registration pattern 66”, hereinafter) including a mark 66K formed by the processing section 50K, a mark 66C formed by the processing section 50C, a mark 66M formed by the processing section 50M, and a mark 66Y formed by the processing section 50Y arranged in the sub-scanning direction.

The registration pattern 66 is formed at equal intervals in the sub-scanning direction (in the moving direction of the conveyance belt 7 illustrated in FIG. 3). Each of the marks 66K, 66C, 66M, and 66Y according to the present embodiment has a rectangular bar shape extending in the main scanning direction (in the direction perpendicular to the sub-scanning direction).

Then, based on a binarization signal outputted from the mark sensor 61, the position of each of the marks 66K, 66Y, 66M, and 66C is detected. Then, the interval in the sub-scanning direction relative to the mark (e.g., the mark 66K) of reference color is calculated for the mark (e.g., the marks 66C, 66M, and 66Y) of each correction color. The interval between the mark of reference color and the mark of each correction color varies when a deviation occurs in the sub-scanning direction. Thus, the amount of deviation in the sub-scanning direction relative to the position of the reference color is identified for each correction color.

In the correction processing, based on the amount of deviation acquired in the acquisition processing, the process conditions (e.g., the exposure position, and the velocity of the conveyance belt 7 or the photosensitive body) for each correction color are adjusted such that the position of the image of each correction color coincides with the position of the image of reference color.

Here, the configuration of the registration pattern 66 described above is merely an example. That is, employable configurations are not limited to this. The employed registration pattern may be a common image pattern used for position deviation correction. For example, a pair of two bar-shaped marks whose at least one is inclined at a predetermined angle relative to a straight line in the main scanning direction may be employed. Such a registration pattern permits identification of the amount of position deviation in the main scanning direction in addition to that in the sub-scanning direction.

Further, similarly to the position deviation correction, the density deviation correction also includes: acquisition processing for acquiring a correction value relative to a predetermined density; and correction processing for correcting an image based on the correction value. Then, in the acquisition processing, each of the processing sections 50Y, 50M, 50C, and 50K forms a density pattern composed of an image pattern having density variation in the sub-scanning direction. Then, the quantities of the light reflected from the density patterns are detected by the sensor shared also in position deviation correction or alternatively another optical sensor. In the present embodiment, for example, the detection is performed by the sensor 61L. Then, the density is identified based on the quantity of the reflected light to calculate the difference from the target density as a correction value. On the other hand, in the correction processing, based on the correction value, the process conditions (e.g., the exposure intensity, the exposure area, and the developing bias) are adjusted for each color such that the target density is maintained.

### [Update Timing for Correction Values]

Next, the update timing for the correction values in the adjustment of the image forming section 10 are described below. The accuracy of correction is maintained higher (more reliable) when the time having elapsed since the acquisition of correction values is shorter. Thus, frequent update of correction values, that is, frequent execution of acquisition processing, improves the image quality. On the other hand, in the update of correction values, marks used for adjustment of the image forming section 10 need be formed. Thus, frequent update of correction values causes a possibility of useless consumption of toner.

Thus, the MFP 100 has: a non-suppression mode in which the frequency of update of correction values is not suppressed; and a suppression mode in which the frequency of update of correction values is suppressed. Each mode is capable of being selected by a user. Then, information on the selected mode is stored as mode information in the memory of the MFP 100.

Specifically, in a non-suppression mode, with adopting as a trigger the time of startup of the MFP 100 or the timing that an execution condition for acquisition processing is satisfied, the MFP 100 executes the acquisition processing and then updates the correction values. That is, occasions of update of correction values are increased so that high image quality is maintained.

On the other hand, in a suppression mode, even when an execution condition for acquisition processing is satisfied, acquisition processing is not immediately executed. That is, acquisition processing is executed in linkage with the processing of a print job. For example, in a case that the execution condition for acquisition processing is defined as the elapse of 1 hour since the execution of the previous acquisition processing, acquisition processing is not executed immediately at the timing of elapse of 1 hour but is executed after the elapse of 1 hour in response to a trigger defined as the start or end of processing of the first print job containing color printing. That is, occasions of update of correction values are reduced so that toner consumption is controlled.

Further, in a suppression mode, when a FAX reception request is received, execution of color printing is restricted. By virtue of this, occasions of update of correction values are reduced so that toner consumption is controlled. Details of a printing procedure for FAX data are described later.

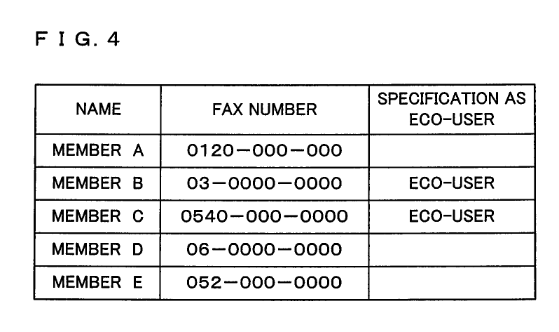

Further, as illustrated in FIG. 4, in the MFP 100, a database 321 (an example of first storage means) storing whether each user is registered as an eco-user is provided in the ROM 32 or the NVRAM 34. In the database 321, a user name, a FAX number, and specification or non-specification as eco-user are stored in a mutually related manner as one record. When receiving a FAX reception request, the MFP 100 judges based on the FAX number whether the user is an eco-user. Then, when the user is an eco-user, the operation is performed automatically in a suppression mode. Here, information used for recognizing an eco-user is not limited to the FAX number, and may be the user name identified from the FAX number.

### [Printing of FAX Data]

### First Embodiment

Next, a procedure of printing FAX data is described below for a system constructed from a FAX device 200 serving as a transmitting-side apparatus and an MFP 100 serving as a receiving-side apparatus.

### [FAX Transmission Processing]

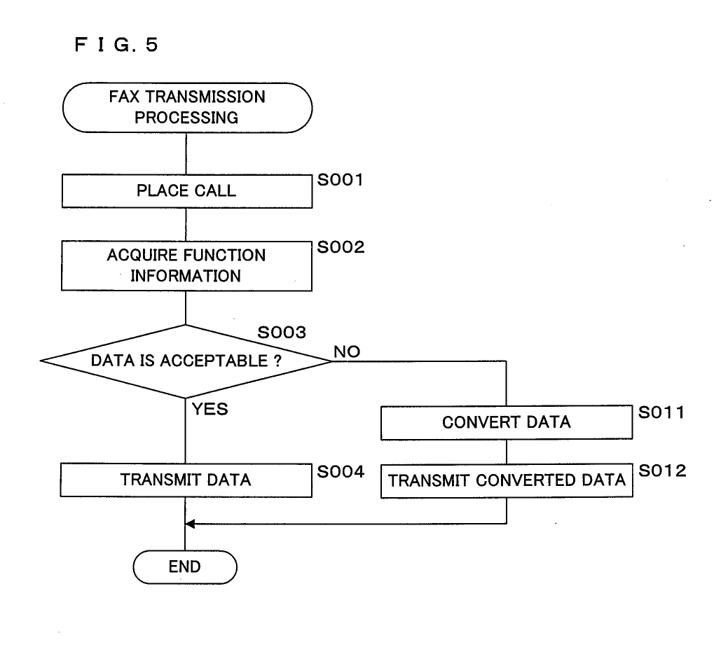

First, FAX transmission processing in the FAX device 200 (an example of conversion means, receiving means, and transmitting means) is described below with reference to the flow chart of FIG. 5. The FAX transmission processing is executed when a FAX transmission request is received.

First, the FAX device 200 (a transmitting-side apparatus) places a call to the MFP 100 (a receiving-side apparatus) (S001). Then, after the line is connected between the FAX device 200 and the MFP 100, the FAX device 200 acquires the function information of the MFP 100 through the FAX interface 237 (S002). The function information contains at least information indicating whether color printing is available. In addition, the function information may contain, for example, the resolution and the transmission speed supported in the receiving-side apparatus.

Then, based on the acquired function information, the control section 230 of the FAX device 200 judges whether FAX data to be transmitted is acceptable in the MFP 100 (S003). For example, in a case that color FAX data is to be transmitted, when color printing is available in the MFP 100, it is judged that the FAX data to be transmitted is acceptable. In contrast, when color printing is not available in the MFP 100, it is judged that the FAX data to be transmitted is unacceptable. When it is judged that the FAX data to be transmitted is acceptable (S003: YES), the control section 230 transmits the FAX data through the FAX interface 237 to the MFP 100 (S004).

In contrast, when it is judged that the FAX data to be transmitted is unacceptable (S003: NO), the control section 230 of the FAX device 200 converts the FAX data such as to meet the function of the MFP 100 (S011). For example, in a case that color FAX data is to be transmitted, when color printing is not available in the MFP 100, the color FAX data is converted into monochrome FAX data. Thereafter, the control section 230 transmits the converted FAX data through the FAX interface 237 to the MFP 100 (S012).

After S004 or S012, the present processing is terminated. That is, the FAX device 200 serving as a transmitting-side apparatus transmits to the MFP 100 the FAX data corresponding to the function of the MFP 100 serving as a receiving-side apparatus.

### [FAX Receiving Processing]

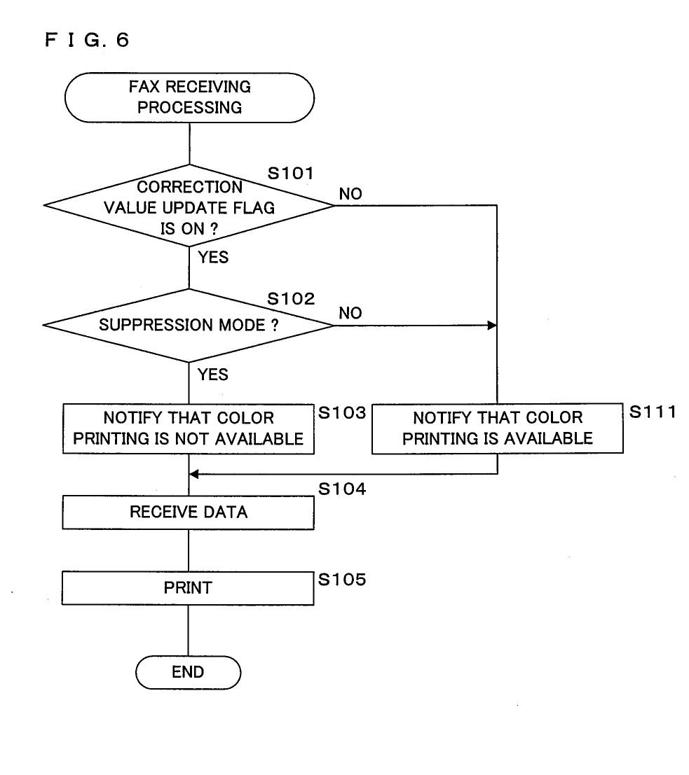

Next, FAX receiving processing in the MFP 100 (an example of notifying means and selecting means) is described below with reference to the flow chart of FIG. 6. The FAX receiving processing is executed when the MFP 100 (receiving-side apparatus) receives a FAX reception request and then the line to the FAX device 200 (transmitting-side apparatus) is connected.

First, the control section 30 of the MFP 100 judges whether a correction value update flag is ON (S101). When an execution condition for acquisition processing is satisfied, the correction value update flag goes from OFF to ON. That is, at S101, it is judged whether the execution condition for acquisition processing is satisfied.

When it is judged that the correction value update flag is ON (S101: YES), the control section 30 of the MFP 100 judges whether a suppression mode is selected (S102). The judgment whether the mode is a suppression mode is performed, for example, by judging whether the FAX number of a sender of FAX data is specified as an eco-user and then, when it is judged that the user is an eco-user, judging that the mode is a suppression mode. Further, when the user is not registered in the database 321, the judgment is performed in accordance with the mode information set in the MFP 100. Here, the order of S101 and S102 may be reversed to each other.

When it is judged that the mode is a suppression mode (S102: YES), the control section 30 of the MFP 100 notifies that color printing is not available, through the FAX interface 37 to the FAX device 200 (S103). Specifically, in the negotiation (a procedure in phase B), a response indicating that color printing is not available is replied. That is, despite that a color printing function is provided, the control section 30 notifies, to the FAX device 200, function information indicating that color printing is not available and hence the printing function is restricted. Thus, the FAX device 200 serving as a transmitting-side apparatus stops the transmission of color FAX data, and transmits to the MFP 100 the FAX data obtained by conversion into monochrome data.

On the other hand, when it is judged that the correction value update flag is OFF (S101: NO) or alternatively when it is judged that the mode is a non-suppression mode (S102: NO), the MFP 100 notifies that color printing is available, through the FAX interface 37 to the FAX device 200 (S111). That is, function information indicating that the printing function is not restricted is notified. Thus, the FAX device 200 serving as a transmitting-side apparatus transmits the color FAX data to the MFP 100 without conversion. Here, the FAX device 200 may transmit monochrome FAX data.

After S103 or S111, the MFP 100 receives through the FAX interface 37 the FAX data transmitted from the FAX device 200 (S104). At that time, even in a case that the FAX device 200 prepares to transmit color FAX data, when the MFP 100 has notified that color printing is not available, FAX data obtained by conversion into monochrome data is transmitted. On the other hand, when the MFP 100 has notified that color printing is available, color or monochrome FAX data is transmitted. Thereafter, the control section 30 of the MFP 100 controls the image forming section 10 so as to print an image onto a sheet based on the FAX data (S105). Then, the line to the FAX device on the transmitting side is disconnected, and then the present processing is terminated.

### [Printing Processing]

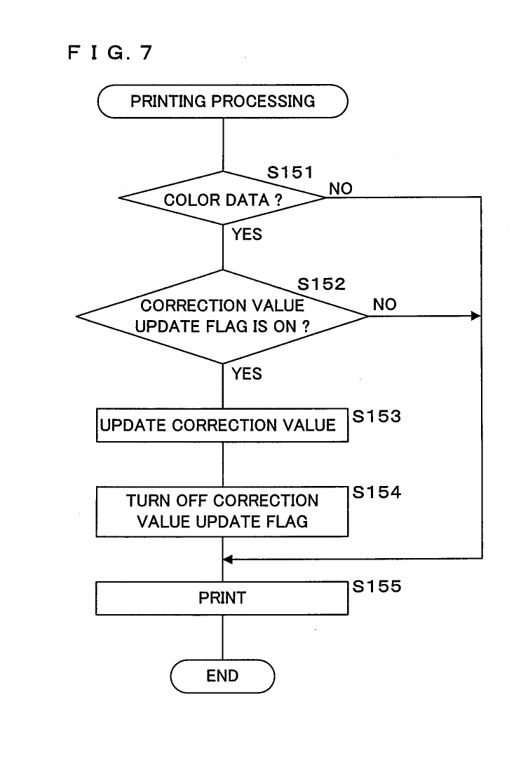

Next, printing processing (an example of execution means) in the MFP 100 is described below with reference to the flow chart of FIG. 7. The printing processing is executed when a printing request is received. Here, in addition to at the time of FAX reception described above, such a printing request is received, for example, at the time of copy processing and at the time of receiving of a printing instruction from an external device such as a PC.

Here, FAX data contains “image data”. When FAX data is to be printed, the control section 30 of the MFP 100 extracts image data from the FAX data, and then generates a “print job” containing the image data. Then, the image forming section 10 of the MFP 100 prints the image onto a sheet based on the print job.

First, the control section 30 of the MFP 100 judges whether the received FAX data is color data (S151). When it is judged that the FAX data is monochrome data (S151: NO), the control section 30 goes to S155 so as to cause the image forming section 10 to perform printing. After S155, the present processing is terminated. That is, when the FAX data is monochrome data, correction values are not updated at the time of printing.

When it is judged that the FAX data is color data (S151: YES), the control section 30 of the MFP 100 judges whether the correction value update flag is ON (S152). Then, when it is judged that the correction value update flag is OFF (S152: NO), the control section 30 goes to S155 so as to cause the image forming section 10 to perform printing. After S155, the present processing is terminated. That is, when the update of correction values is unnecessary, correction values are not updated at the time of printing. Here, the order of S151 and S152 may be reversed to each other.

When it is judged that the correction value update flag is ON (S152: YES), the control section 30 of the MFP 100 updates the correction values (S153). That is, the control section 30 executes the acquisition processing so as to acquire new correction values. After updating the correction values, the control section 30 turns OFF the correction value update flag (S154), and then causes the image forming section 10 to perform printing with performing the correction processing using the new correction values (S155). After S155, the present processing is terminated.

That is, in the FAX receiving processing according to the first embodiment, when the mode is a suppression mode and the correction value update flag is ON (that is, the execution condition for acquisition processing is satisfied), despite that a color printing function is provided, the MFP 100 notifies to the FAX device 200 that color printing is not available. Thus, the MFP 100 receives monochrome FAX data and then prints a monochrome image. In the printing processing, in case of a monochrome image, correction values are not updated even when the correction value update flag is ON. Thus, in comparison with a configuration that availability of color printing is solely notified, occasions of update of correction values in a suppression mode are reduced and hence the number of times of execution of acquisition processing is reduced.

### Second Embodiment

Next, a second embodiment of FAX data printing is described below. The MFP 100 according to the second embodiment has a “batch printing mode” that when FAX data is received in a state that the correction value update flag is ON, the received FAX data is stored into the memory, and then in response to a trigger defined as the update of correction values (that is, execution of acquisition processing) performed later, the FAX data stored in the memory is printed collectively. The batch printing mode is capable of being selected by a user. Then, information on the selected batch printing mode is stored as mode information in the memory of the MFP 100.

### [FAX Receiving Processing]

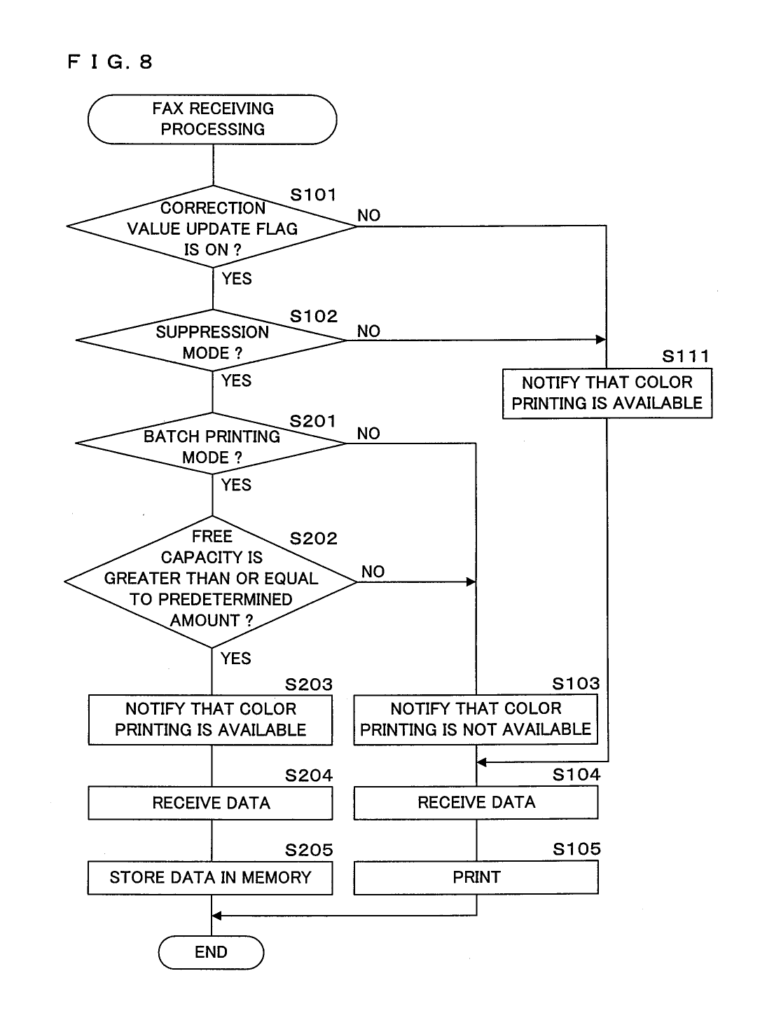

FAX receiving processing (an example of the second storage means) of an MFP having a batch printing mode is described below with reference to the flow chart of FIG. 8. Here, processing steps like those of the FAX receiving processing according to the first embodiment are designated by like numerals. Further, the FAX transmission processing in the FAX device serving as a transmitting-side apparatus (see FIG. 5) and the printing processing (see FIG. 7) in the FAX device serving as a receiving-side apparatus are similar to those in the first embodiment. Thus, their description is omitted.

First, the control section 30 of the MFP 100 judges whether the correction value update flag is ON (S101), and then judges whether the mode is a suppression mode (S102). When it is judged that the correction value update flag is OFF (S101: NO) or alternatively when it is judged that the mode is a non-suppression mode (S102: NO), the control section 30 notifies that color printing is available, through the FAX interface 37 to the FAX device 200 (S111). Then, the control section 30 receives color or monochrome FAX data through the FAX interface 37 (S104). Thereafter, the control section 30 of the MFP 100 controls the image forming section 10 so as to print an image onto a sheet based on the FAX data (S105).

When it is judged that the correction value update flag is ON (S101: YES) and that the mode is a suppression mode (S102: YES), the control section 30 of the MFP 100 judges whether the mode is a batch printing mode (S201). When it is judged that the mode is a batch printing mode (S201: YES), the control section 30 judges whether the free capacity of the memory area ensured for a batch printing mode in the RAM 33 or the NVRAM 34 is greater than or equal to a predetermined amount (S202). When it is judged that the mode is not a batch printing mode (S201: NO), similarly to the first embodiment, the control section 30 notifies that color printing is not available, through the FAX interface 37 to the FAX device 200 (S103). Further, when it is judged that the free capacity of the memory is smaller than the predetermined amount (S202: NO), a high possibility is expected that the received FAX data cannot be stored in the memory area. Thus, the control section 30 notifies that color printing is not available, through the FAX interface 37 to the FAX device 200 (S103). After S103, the control section 30 receives the FAX data obtained by conversion into monochrome data, from the FAX device 200 through the FAX interface 37 (S104). Then, the control section 30 controls the image forming section 10 so as to print an image onto a sheet based on the FAX data (S105).

On the other hand, when it is judged that the free capacity of the memory is greater than or equal to the predetermined amount (S202: YES), similarly to S111, the control section 30 of the MFP 100 notifies that color printing is available, through the FAX interface 37 to the FAX device 200 (S203). Thereafter, the control section 30 receives through the FAX interface 37 the color or monochrome FAX data from the FAX device 200 (S204). Then, without printing an image onto a sheet based on FAX data, the control section 30 stores the received FAX data in the memory area (S205). After S205 or S105, the present processing is terminated.

### [Printing Processing for Stored Data]

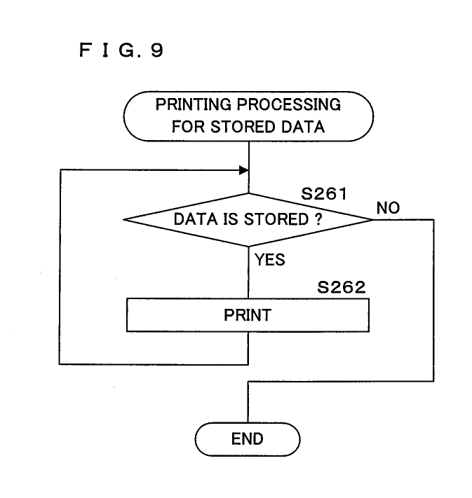

Then, printing processing (an example of the processing means) of printing the FAX data stored in the memory is described below with reference to the flow chart of FIG. 9. The printing processing for the stored FAX data is executed in response to a trigger defined as the update of correction values (that is, execution of acquisition processing). Here, the update of correction values is performed, for example, in response to a trigger defined as the startup of the MFP 100 or alternatively the start of another print job containing color printing.

First, the control section 30 of the MFP 100 judges whether any FAX data is stored in the memory area ensured for a batch printing mode (S261). When it is judged that FAX data is not stored (S261: NO), the present processing is terminated.

In contrast, when it is judged that FAX data is stored (S261: YES), the control section 30 of the MFP 100 processes the stored FAX data in the order of storage date and time so as to generate print jobs, and then causes the image forming section 10 to perform printing based on the generated print jobs (S262). Thus, in response to a trigger defined as the processing of another print job, the stored FAX data is printed collectively. After the printing, the procedure returns to S261. Thus, the control section 30 of the MFP 100 judges whether any additional FAX data has been stored during the printing. Then, when printing has been completed for the entirety of the stored FAX data (S261: NO), the present processing is terminated.

Here, a situation that FAX data is stored for a long time is unpreferable. Thus, when FAX data has been stored longer than a predetermined time period, correction values may be updated forcedly. This avoids long-term storage of FAX data.

That is, in the FAX receiving processing according to the second embodiment, when the mode is a batch printing mode and a suppression mode and the correction value update flag is ON (that is, the execution condition for acquisition processing is satisfied), FAX data is stored in a predetermined memory area. Then, the FAX data stored in the memory area is printed in response to a trigger defined as the execution of acquisition processing. Thus, at the time of receiving of FAX data, printing and the update of correction values are not performed. This reduces the number of times of execution of acquisition processing.

Here, when FAX data cannot be stored in the memory, the control section 30 of the MFP 100 notifies to the FAX device 200 that color printing is not available. The frequency of occasions of this notification is lower than in the first embodiment. Thus, occasions that printing is performed in a state that the printing function is restricted are reduced.

As described in detail, when receiving a FAX reception request in a state that the execution condition for acquisition processing is satisfied, the MFP 100 of the present embodiment replies function information indicating that the printing function is restricted (for example, information indicating that color printing is not available), to the FAX device 200 of the sender in the negotiation (phase B) for establishing communication, such that a trigger for execution of acquisition processing should not be generated. Thus, the FAX device 200 of the sender does not transmit the FAX data to be processed as an execution target of acquisition processing. As a result, acquisition processing is not executed. For example, as in the present embodiment, even when the FAX device 200 of the sender is notified that color printing is not available and then transmits FAX data obtained by conversion into monochrome data, acquisition processing in the MFP 100 is not linked to the printing of the monochrome FAX data. Thus, the number of times of forming the marks used for adjustment of the image forming section 10 is reduced.

Here, the embodiments given above are merely illustrative and do not limit the present invention. Thus, obviously, various kinds of improvements and modifications are allowed in the present invention without departing from the spirit. For example, the employed image forming apparatus is not limited to an MFP, and may be any apparatus such as a FAX device provided with a printing function and a color FAX receiving function.

Further, in the embodiments given above, the receiving-side apparatus judges whether the mode is a suppression mode, depending on the eco-user information and the mode information set by a user. Instead, the mode judgment may be performed depending only on the mode information or only on the eco-user information. When the judgment is to be performed depending only on the eco-user information, for example, all users not registered in the database 321 may be judged as eco-users. Further, the receiving-side apparatus may select the mode based on the information other than eco-user information and the mode information. For example, when the amount of remaining toner is smaller than a predetermined amount, the mode may be judged as a suppression mode.

Further, in the embodiments given above, the receiving-side apparatus has a suppression mode and a non-suppression mode. Then, in a suppression mode, the receiving-side apparatus notifies that color printing is not available, to the transmitting-side apparatus. However, employable configurations are not limited to this. For example, when a FAX reception request is received in a state that the execution condition for acquisition processing is satisfied, a situation that color printing is not available may always be notified.

Further, in the embodiments given above, in a case that color FAX data is to be transmitted, when a situation that color printing is not available is notified from the receiving-side apparatus, the transmitting-side apparatus converts the data into monochrome FAX data and then transmits the converted data to the receiving-side apparatus. However, employable configurations are not limited to this. That is, the transmission itself of FAX data may be stopped. This stoppage of FAX data transmission also reduces the number of times of execution of acquisition processing in the receiving-side apparatus.

Further, in the embodiments given above, the receiving-side apparatus notifies the permission or non-permission of color printing, to the transmitting-side apparatus. However, functions to be notified are not limited to this. For example, the range of supported resolution may be notified. That is, in case of low resolution, high quality is not required in comparison with a case of high resolution. Thus, in case of low resolution, color printing may be performed with omitting the update of correction values. In this case, in the printing processing, even when the data is color data (S151: YES) and the correction value update flag is ON (S152: YES), when the required resolution is lower than or equal to a predetermined value, printing is performed without the update of correction values. Then, in the FAX receiving processing, for example, when the correction value update flag is ON (S101: YES) and the mode is a suppression mode (S102: YES), a situation is notified that color printing in a resolution higher than a predetermined value is not available. In this configuration, even in case of color FAX data, when the resolution is low, color FAX data is transmitted. Then, color printing of the FAX data is performed without the execution of acquisition processing. This reduces the number of times of conversion of data in the transmitting-side apparatus.

Further, in the configuration that in case of low resolution, color printing is performed with omitting the update of correction values, a configuration may be employed that in the FAX receiving processing, for example, when the correction value update flag is ON (S101: YES) and the mode is a suppression mode (S102: YES), the receiving-side apparatus at S103 may notify that printing in a resolution higher than a predetermined value is not available. That is, the contents of notification may be not the permission or non-permission of color printing. In this configuration, the transmitting-side apparatus transmits FAX data obtained by conversion into a resolution lower than or equal to the predetermined value, to the receiving-side apparatus. This FAX data having a low resolution does not serve as an execution target of acquisition processing. Thus, the number of times of execution of acquisition processing is reduced in the receiving-side apparatus.

Further, in the embodiments given above, in the receiving-side apparatus, printing is performed before the update of correction values (that is, the execution of acquisition processing). However, employable configurations are not limited to this. That is, the update of correction values may be performed during the printing or alternatively after the printing.

Here, according to the present invention, it is possible to avoid receiving of color FAX data that may serve as a trigger for execution of acquisition processing.

Further, according to the present invention, it is possible to avoid receiving of high-resolution FAX data that may serve as a trigger for execution of acquisition processing. Moreover, since high image quality is seldom required in low-resolution printing, a configuration may be employed that acquisition processing is not executed for low resolution printing even in case of color printing.

Further, some users may be unsatisfied at the restriction of the printing function. Thus, according to the present invention, a configuration is preferable that for example, is capable of selecting reception of color FAX data without restriction of the function of the image forming means.

Here, as the operation to be performed when FAX data is received in a state that the execution condition for acquisition processing is satisfied, at least three patterns are employable like that acquisition processing is executed and then printing is performed (aspect 1), printing is performed at a low image quality without execution of acquisition processing (aspect 2), and printing is performed after a standby state that execution of acquisition processing in association with the processing of another print job is awaited (aspect 3). Here, in aspect 3, a configuration may be employed that, for example, color FAX data alone is brought into a standby state and that monochrome FAX data is printed immediately.

Further, according to the present invention, the apparatus (or the user) of the sender can be identified by a telephone number or the like. Then, when selection is performed based on the contents of selection corresponding to the sender, convenience is improved further.

Further, in the image forming apparatus according to the present invention, when FAX data can be stored in the second storage means, the FAX data is stored in the second storage means. Then, in response to a trigger defined as the execution of acquisition processing performed thereafter, printing is performed based on the FAX data. This realizes printing in the form required by the sender. Further, the FAX data stored in the second storage means is printed in linkage with another color printing. This avoids an increase in the number of times of execution of acquisition processing. Further, in the image forming apparatus according to the present invention, only when FAX data can be stored in the second storage means, notification is performed that the function of the image forming means is restricted. This reduces the number of times of notification that may cause a user's dissatisfaction.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. An image forming apparatus comprising:
a receiving section receiving a FAX reception request and FAX data;
a processing section processing the received FAX data so as to generate a print job;
an image forming section capable of forming a color image based on the print job;
an execution section, in response to a trigger defined as start or end of processing of a print job containing color image formation, executing acquisition processing for acquiring information used for adjusting the image forming section;
a controller judging whether an execution condition for the acquisition processing is satisfied; and
a notification section, when the receiving section receives a FAX reception request in a state that the controller has judged that the execution condition for acquisition processing has been satisfied, notifying function information concerning a function of the image forming section, to a sender of the FAX reception request.

2. The image forming apparatus according to claim 1, wherein
the notification section notifies as the function information a function of the image forming section that is executable without satisfying the execution condition for acquisition processing.

3. The image forming apparatus according to claim 2, wherein
the notification section notifies, as the function information, that the image forming section is not available for color image formation.

4. The image forming apparatus according to claim 3, wherein
the execution section executes the acquisition processing in response to a trigger defined as start or end of processing of a print job containing color formation for an image having a resolution higher than a predetermined value, and
the notification section notifies, as the function information, that the image forming section is not available for color formation for an image having a resolution higher than the predetermined value.

5. The image forming apparatus according to claim 2, wherein
the notification section notifies, as the function information, that the function of the image forming section is not restricted, and
when the receiving section receives a FAX reception request in a state that the controller has judged that the execution condition for acquisition processing has been satisfied, the controller selects whether the notification section should notify as the function information a function of the image forming section that is executable without satisfying the execution condition for acquisition processing or alternatively the notification section should notify, as the function information, that the function of the image forming section is not restricted.

6. The image forming apparatus according to claim 5, further comprising a first storage section storing the contents of selection performed by the controller in correspondence to the sender of the FAX reception request and the FAX data,
wherein the controller performs selection based on the contents of selection stored in the first storage section.

7. The image forming apparatus according to claim 5, further comprising a second storage section storing the FAX data received by the receiving section,
wherein when the receiving section receives a FAX reception request in a state that the controller has judged that the execution condition for acquisition processing has been satisfied, the second storage section stores the FAX data transmitted in response to the FAX reception request,
on condition that the acquisition processing has been executed in response to a trigger defined as start or end of processing of another print job containing color image formation, the processing section processes the FAX data stored in the second storage section so as to generate a print job, and then the image forming section forms an image based on the print job,
the controller judges whether a free capacity of the second storage section is smaller than a predetermined amount, and
when the receiving section receives a FAX reception request in a state that the controller has judged that the free capacity of the second storage section is smaller than the predetermined amount and has judged that the execution condition for acquisition processing has been satisfied, the controller causes the notification section to notify, as the function information, that the function of the image forming section is restricted.

8. The image forming apparatus according to claim 1, wherein
as the acquisition processing, the execution section, by using the image forming section, forms a mark used for adjusting the image forming section, then detects the mask, and then based on a detection result of the formed mark, acquires a correction value used for adjusting the image forming section.

9. An image forming apparatus comprising:
receiving means receiving a FAX reception request and FAX data;
processing means processing the received FAX data so as to generate a print job;
image forming means capable of forming a color image based on the print job;
execution means, in response to a trigger defined as start or end of processing of a print job containing color image formation, executing acquisition processing for acquiring information used for adjusting the image forming means;
judging means judging whether an execution condition for the acquisition processing is satisfied; and
notification means, when the receiving means receives a FAX reception request in a state that the judging means has judged that the execution condition for acquisition processing has been satisfied, notifying function information concerning a function of the image forming means, to a sender of the FAX reception request.

10. The image forming apparatus according to claim 9, wherein
the notification means notifies as the function information a function of the image forming means that is executable without satisfying the execution condition for acquisition processing.

11. The image forming apparatus according to claim 10, wherein
the notification means notifies, as the function information, that the image forming means is not available for color image formation.

12. The image forming apparatus according to claim 11, wherein
the execution means executes the acquisition processing in response to a trigger defined as start or end of processing of a print job containing color formation for an image having a resolution higher than a predetermined value, and
the notification means notifies, as the function information, that the image forming means is not available for color formation for an image having a resolution higher than the predetermined value.

13. The image forming apparatus according to claim 10, wherein
the notification means notifies, as the function information, that the function of the image forming means is not restricted, and
the image forming apparatus further comprises selecting means, when the receiving means receives a FAX reception request in a state that the judging means has judged that the execution condition for acquisition processing has been satisfied, selecting whether the notification means should notify as the function information a function of the image forming means that is executable without satisfying the execution condition for acquisition processing or alternatively the notification means should notify, as the function information, that the function of the image forming means is not restricted.

14. The image forming apparatus according to claim 13, further comprising first storage means storing the contents of selection performed by the selecting means in correspondence to the sender of the FAX reception request and the FAX data,
wherein the selecting means performs selection based on the contents of selection stored in the first storage means.

15. The image forming apparatus according to claim 13, further comprising second storage means storing FAX data,
wherein when the receiving means receives a FAX reception request in a state that the judging means has judged that the execution condition for acquisition processing has been satisfied, the second storage means stores the FAX data transmitted in response to the FAX reception request,
on condition that the acquisition processing has been executed in response to a trigger defined as start or end of processing of another print job containing color image formation, the processing means processes the FAX data stored in the second storage means so as to generate a print job,
the image forming means forms an image based on the print job,
the judging means judges whether a free capacity of the second storage means is smaller than a predetermined amount, and
when the receiving means receives a FAX reception request in a state that the judging means has judged that the free capacity of the second storage means is smaller than the predetermined amount and has judged that the execution condition for acquisition processing has been satisfied, the selecting means selects that the notification means should notify, as the function information, that the function of the image forming means is restricted.

16. The image forming apparatus according to claim 9, wherein
as the acquisition processing, the execution means, by using the image forming means, forms a mark used for adjusting the image forming means, then detects the mask, and then based on a detection result of the formed mark, acquires a correction value used for adjusting the image forming means.
